(19) United States
(12) Patent Application Publication
(10) Pub. No.: US 2013/0242878 A1
(43) Pub. Date: Sep. 19, 2013

(54) ROUTER WITH STORAGE DEVICE AND CONTROL METHOD THEREOF

(71) Applicant: Young Soo Ji, Seoul (KR)

(72) Inventor: Young Soo Ji, Seoul (KR)

(73) Assignee: LG INNOTEK CO., LTD., Seoul (KR)

(21) Appl. No.: 13/990,150

(22) PCT Filed: Nov. 29, 2011
(86) PCT No.: PCT/KR11/09146

§ 371 Date: May 29, 2013

(30) Foreign Application Priority Data
Nov. 29, 2010 (KR) 10-2010--0119969

(51) Int. Cl. H04L 12/70

(52) U.S. Cl. CPC H04L 49/10
USPC 370/328

(57) ABSTRACT

A router with a storage device is provided. When a terminal communicates with a first or second communication unit, the terminal may store data into an internal storage device, and read and delete the stored data. When an external storage device is connected to a wired interface unit provided to the router, data stored in the external storage device may be uploaded to be stored into the internal storage device, and the data stored in the internal storage device may be backed up to the external storage device. When the terminal is connected to the wired interface unit, the terminal may store data into the internal storage device, and read and delete the stored data.

### TECHNICAL FIELD

The present invention relates to a router with a storage device and a control method thereof. More particularly, the present invention relates to a router which allows a terminal such as a computer to wirelessly access a network such as the Internet for performing communication and includes an internal storage device for storing predetermined data, and to a control method thereof.

### BACKGROUND ART

A router typically includes a first communication unit for performing a Wireless Fidelity (Wi-Fi) communication with an external terminal such as a computer, a second communication unit for performing a Worldwide Interoperability for Microwave Access (WiMAX), Wireless Broadband Internet (WiBro), High-Speed Uplink Packet Access (HSUPA), or Long Term Evolution (LTE) communication with an external network, and a control unit for a communication between the first and second communication units.

Such a router serves to intermediate between a terminal such as a computer and a network so that the terminal accesses and communicates with the network.

However, the router is not provided with a storage device for storing data. Therefore, a user of the terminal cannot use the router as an external storage device when the user needs to use the router as the external storage device.

### DISCLOSURE OF INVENTION

### Technical Problem

Embodiments provide a router which includes a storage device to be used as an external storage device by a user if necessary, and a control method thereof.

### Solution to Problem

In one embodiment, a router with a storage device includes a first communication unit configured to communicate with a first terminal; a second communication unit configured to perform communication for accessing a network; an internal storage device capable of storing data; and a controller configured to link the first and second communication units so that the first terminal accesses the network, and control the internal storage device to store, read, or delete data in response to a command from the first terminal.

The controller may control the internal storage device to store, read, or delete data in response to a command from a second terminal when the second terminal communicates with the second communication unit through the network.

The first communication unit may perform a Wireless Fidelity (Wi-Fi) communication with the first terminal.

The second communication unit may access the network by using one of communication technologies including Worldwide Interoperability for Microwave Access (WiMAX), Wireless Broadband Internet (WiBro), High-Speed Uplink Packet Access (HSUPA), and Long Term Evolution (LTE).

The router with the storage device may include a wired interface unit configured to interface with an external device for data access, and the controller may control the internal storage device to store, read, or delete data in response to a command from a third terminal when the external device connected to the wired interface unit is the third terminal.

The router with the storage device may include a wired interface unit configured to interface with an external device for data access; a key signal input unit configured to generate a key signal according to handling of a user, and output the generated signal to the controller; and a display unit configured to display an operation of the router according to a command from the controller, wherein the controller may upload data stored in an external storage device to store the uploaded data into the internal storage device, or back up data stored in the internal storage device to store the backed-up date into the external storage device in response to the key signal of the key signal input unit when the external device connected to the wired interface unit is the external storage device.

The internal storage device may be a Hard Disk Drive (HDD) or Solid State Disk (SSD).

In another embodiment, a method for controlling a router with a storage device includes: interpreting a command received from a first terminal when the first terminal is connected to and communicates with a first communication unit; operating a second communication unit for accessing a network, and linking the first and second communication units so that the first terminal accesses the network when the command received from the first terminal is a network access command; and controlling an internal storage device in response to a data management command from the first terminal when the command received from the first terminal is the data management command.

The method may include controlling the internal storage device in response to a command from a second terminal when the second terminal is connected to the second communication unit.

The method may include determining a type of an external device when the external device is connected to a wired interface unit; and selecting data among data stored in an external storage device in response to a key signal received from a key signal input unit, uploading the selected data, and storing the uploaded data into the internal storage device when the external device is determined as the external storage device.

The method may include selecting data among data stored in the internal storage device according to the key signal received from the key signal input unit, backing up the selected data, and storing the backed-up data into the external storage device.

The method may include deleting the backed-up data from the internal storage device when the key signal input unit inputs a data deletion command, after the backing up of the data.

The method may include controlling the internal storage device in response to a command from a third terminal when the external device connected to the wired interface unit is the third terminal.

The controlling of the internal storage device may include storing data into and reading and deleting data from the internal storage device.

### Advantageous Effects of Invention

Embodiments provide a router which includes a storage device to be used as an external storage device by a user if necessary, and a control method thereof.

### BRIEF DESCRIPTION OF DRAWINGS

FIG. 1 is a block diagram illustrating a router with a storage device according to an embodiment.

FIGS. 2A and 2B are flowcharts illustrating a method for controlling the router with the storage device, according to an embodiment.

### MODE FOR THE INVENTION

The following detailed description just describes exemplary embodiments. The principle and concept of the embodiments are provided for effective and clear description.

Therefore, unnecessary detailed structures are not provided in order not to obscure the basic concept of the embodiments. Various forms of the embodiments are described with reference to the drawings so that those skilled in the art carry out the embodiments.

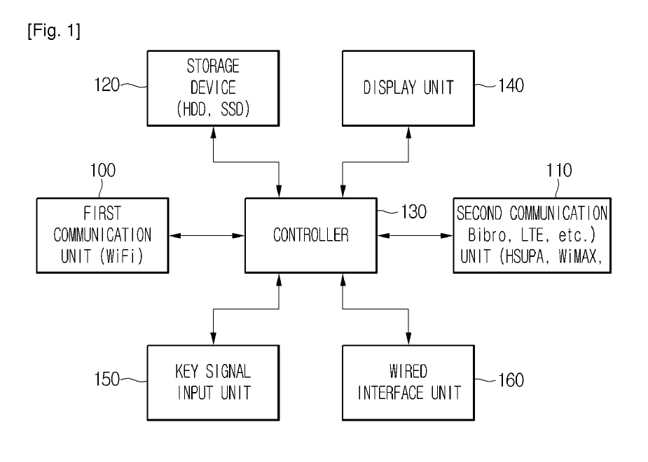

FIG. 1 is a block diagram illustrating a router with a storage device according to an embodiment. Herein, reference numeral 100 indicates a first communication unit. The first communication unit performs, e.g., a Wireless Fidelity (Wi-Fi) communication with a first terminal (not illustrated in the drawing) such as a computer.

Reference numeral 110 indicates a second communication unit. The second communication unit 110 performs, e.g., a Worldwide Interoperability for Microwave Access (WiMAX), Wireless Broadband Internet (WiBro), High-Speed Uplink Packet Access (HSUPA), or Long Term Evolution (LTE) communication with an external network such as the Internet.

Reference numeral 120 indicates an internal storage device. The internal storage device 120 stores predetermined data by using, e.g., a Hard Disk Drive (HDD) or Solid State Disk (SSD).

Reference numeral 130 indicates a controller. The controller 130 links the first communication unit 100 and the second communication unit 110 so that the first terminal accesses a network. The controller 130 also controls the internal storage device 120 to store, read, or delete predetermined data.

Reference numeral 140 indicates a display unit. The display unit 140 is controlled by the controller 130 to display a current operation state of the router.

Reference numeral 150 indicates a key signal input unit. The key signal input unit 150 is provided with a plurality of keys and generates a signal corresponding to the keys selected by a user to output the generated signal to the controller 130.

Reference numeral 160 indicates a wired interface unit. The wired interface unit 160 is provided with, e.g., a Universal Serial Bus (USB) port, for interfacing with an external storage device connected to the USB port.

According to the above-described router, the controller 130 interprets an operation command inputted by the external first terminal (not illustrated in the drawing) when the first terminal communicates with and is connected to the first communication unit 100.

When the operation command inputted by the first terminal is a network access command, the controller 130 operates the second communication unit 110 to access the network, and links the first and second communication units 100 and 110 to thereby allow the first terminal to communicate with the network through the router.

When the operation command is a command for managing the data stored in the internal storage device 120, the controller 130 controls the internal storage device 120 in response to the command from the first terminal.

That is, the controller 130 controls the internal storage device 120 to store, read, or delete predetermined data in response to the command from the first terminal.

Further, when a second terminal (not illustrated in the drawing) connected to the network is connected to the second communication unit 110 through the Transmission Control Protocol/Internet Protocol (PCT/IP) or File Transfer Protocol (FTP), the controller 130 controls the internal storage device 120 in response to a command from the second terminal.

The controller 130 also determines whether an external device (not illustrated in the drawing) is connected to the wired interface unit 160.

When the external device is connected to the wired interface unit 160, the controller 130 determines whether the connected external device is an external storage device or third terminal.

When the external device connected to the wired interface unit 160 is determined as the external storage device, the controller 130 determines whether an upload command or backup command is inputted through the key signal input unit 150.

When the upload command is inputted through the key signal input unit 150, the controller 130 uploads data selected from the data of the external storage device to store the selected data into the internal storage device 120.

When the backup command is inputted through the key signal input unit 150, the controller 130 backs up data selected from the data of the internal storage device 120 to store the selected data into the external storage device.

When the external device connected to the wired interface unit 160 is the third terminal, the controller 130 controls the internal storage device 120 to store, read, or delete predetermined data in response to a command from the third terminal.

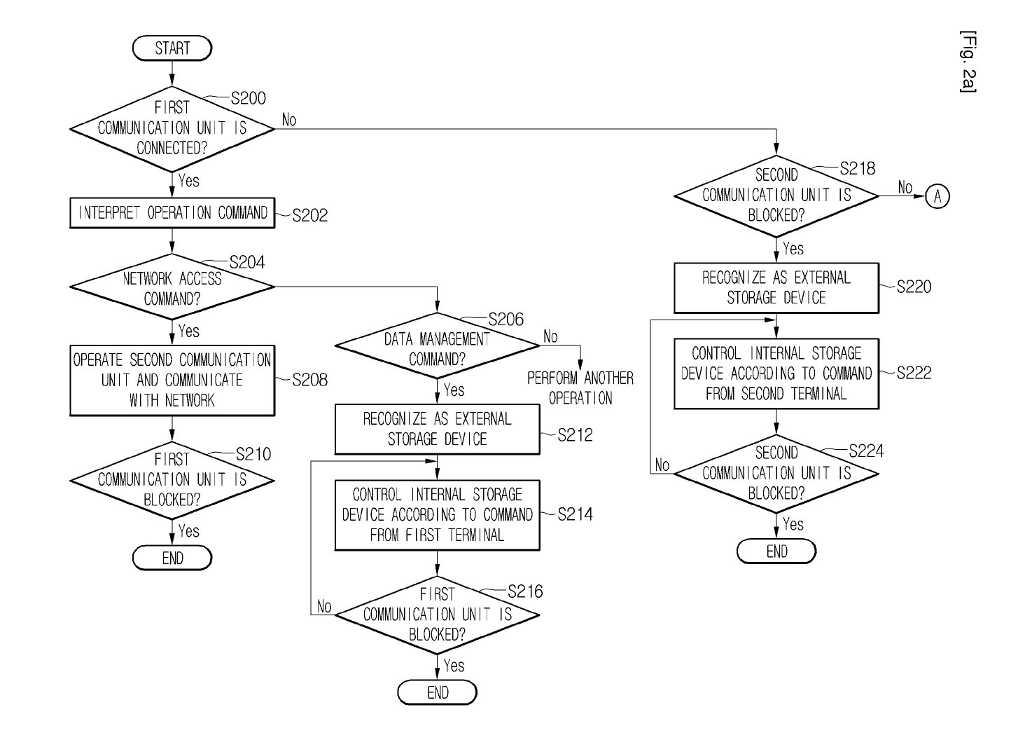

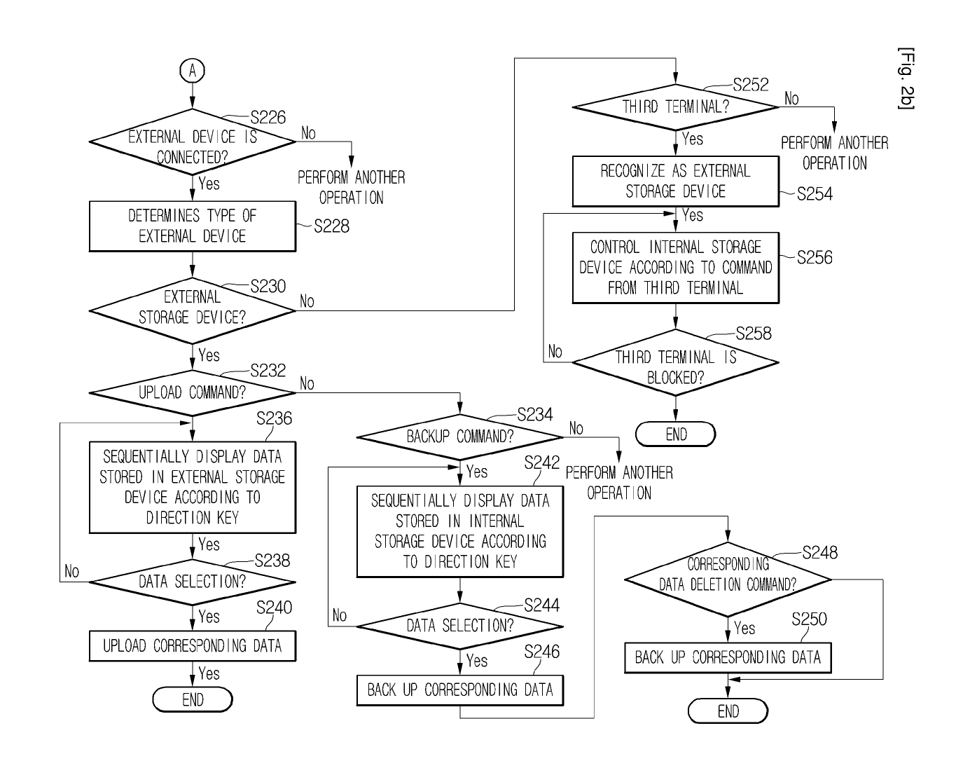

FIGS. 2A and 2B are flowcharts illustrating a method for controlling the router with the storage device, according to an embodiment. Referring to FIG. 2A, the controller 130 determines whether the first terminal is connected to and communicates with the first communication unit 100 in operation S200.

When it is confirmed that the first terminal is connected to and communicates with the first communication unit 100 according to a result of the determination, the controller 130 interprets the operation command inputted through the first communication unit 100 from the first terminal in operation S202, and determines whether the operation command is for accessing network or managing the data stored in the internal storage device 120 in operations S204 and S206.

When it is confirmed, according to a result of the determination, that the operation command inputted by the first terminal is the network access command, the controller 130 operates the second communication unit 110 to access the network, and links the first and second communication units 100 and 110 to thereby allow the first terminal to communicate with the network through the router in operation S208.

Further, the controller 130 determines whether the communication between the first terminal and the first communication unit 100 is blocked in operation S210.

When it is confirmed, according to a result of the determination, that the communication between the first terminal and the first communication unit 100 is not blocked, the controller 130 repeats operation S208 so that the first terminal communicates with the network through the router.

When it is confirmed, according to the result of the determination, that the communication between the first terminal and the first communication unit 100 is blocked, the controller 130 terminates the operation for allowing the first terminal to communicate with the network through the router.

Meanwhile, when it is confirmed, according to the result of the determination of operation S206, that the operation command inputted by the first terminal is a command for managing the data stored in the internal storage device 120, the controller 130 recognizes the router as an external storage device of the first terminal in operation S212, and controls the internal storage device 120 in response to the command from the first terminal.

That is, the controller 130 controls the internal storage device 120 to store, read, or delete predetermined data in response to the command from the first terminal.

In this state, the controller 130 determines whether the communication between the first terminal and the first communication unit 100 is blocked in operation S216.

When it is confirmed, according to a result of the determination, that the communication between the first terminal and the first communication unit 100 is not blocked, the controller 130 repeatedly controls the internal storage device 120 to store, read, or delete predetermined data in response to the command from the first terminal.

When it is confirmed, according to the result of the determination, that the communication between the first terminal and the first communication unit 100 is blocked, the controller 130 terminates the operation for controlling the internal storage device 120 in response to the command from the first terminal.

Meanwhile, when the first communication unit 100 is not connected in operation S200, the controller 130 determines whether the second terminal (not illustrated in the drawing) connected to the network is connected to the second communication unit 110 through the PCT/IP or FTP.

When it is confirmed, according to a result of the determination, that the second terminal is connected to the second communication unit 110, the controller 130 recognizes the router as an external storage device of the second terminal in operation S220, and controls the internal storage device 120 in response to the command from the second terminal.

In this state, the controller 130 determines whether the communication between the second terminal and the second communication unit 110 is blocked in operation S224.

When it is confirmed, according to a result of the determination, that the communication between the second terminal and the second communication unit 110 is not blocked, the controller 130 repeatedly controls the internal storage device 120 to store, read, or delete predetermined data in response to the command from the second terminal.

When it is confirmed, according to the result of the determination, that the communication between the second terminal and the second communication unit 110 is blocked, the controller 130 terminates the operation for controlling the internal storage device 120 in response to the command from the second terminal.

Meanwhile, when the second terminal is not connected to the second communication unit 110 in operation S218, the controller 130 determines whether the external device (not illustrated in the drawing) is connected to the wired interface unit 160 as illustrated in FIG. 2B in operation S226.

When it is confirmed, according to a result of the determination, that the external device is connected to the wired interface unit 160, the controller 130 determines a type of the external device in operation S228, and determines whether the external device is an external storage device such as a USB memory or external hard disk in operation S230.

When it is confirmed, according to a result of the determination, that the external device connected to the wired interface unit 160 is the external storage device, the controller 130 determines whether the upload or backup command is inputted through the key signal input unit 150 in operations S232 and S234.

When it is confirmed, according to a result of the determination, that the upload command is inputted through the key signal input unit 150, the controller 130 sequentially displays the data stored in the external storage device connected to the wired interface unit 160 on the display unit 140 in response to a signal of a direction key of the key signal input unit 150 in operation S236, and determines whether data to be uploaded are selected in operation S238.

In this state, when the data to be uploaded are not selected, the controller 130 goes back to operation S236 to repeatedly display the data stored in the external storage device on the display unit 140 in response to the signal of the direction key of the key signal input unit 150, and determine whether the data to be uploaded are selected.

Herein, one piece or a plurality of pieces of the data may be selected to be uploaded.

When it is completed to select the data to be uploaded, the controller 130 uploads the corresponding data stored in the external storage device, stores the uploaded data into the internal storage device 120, and terminates the uploading operation.

Further, when the upload command in not inputted in operation S232 and the backup command is inputted in operation S234, the controller 130 sequentially displays the data stored in the internal storage device 120 on the display unit 140 in response to the signal of the direction key of the key signal input unit 150 in operation S242, and determines whether data to be backed up are selected in operation S244.

Herein, one piece or a plurality of pieces of the data may be selected to be backed up.

When it is completed to select the data to be backed up, the controller 130 backs up the corresponding data stored in the internal storage device 120 to store the backed-up data into the external storage device connected to the wired interface unit 160 in operation S246.

In this state, when the backup operation is completed, the controller 130 determines whether a command for deleting the backed-up data from the internal storage device 120 is inputted through the key signal input unit 150 in operation S248.

When it is confirmed, according to a result of the determination, that the deletion command is inputted, the controller 130 deletes the backed-up data from the internal storage device 120 in operation S250 and terminates the backup operation.

On the contrary, when it is confirmed, according to the result of the determination, that the deletion command is not inputted, the controller 130 terminates the backup operation without deleting the backed-up data from the internal storage device 120.

Meanwhile, when the external device connected to the wired interface unit 160 is not a storage device, the controller 130 determines whether the connected external device is a third terminal such as a computer in operation S252.

When it is confirmed, according to the result of the determination, that the third terminal is connected to the wired interface unit 160, the controller 130 recognizes the router as an external storage device of the third terminal in operation S254, and controls the internal storage device 120 in response to the command from the third terminal in operation S256.

In this state, the controller 130 determines whether the third terminal is cut off from the wired interface unit 160 in operation S258.

When it is confirmed, according to a result of the determination, that the communication between the third terminal and the second communication unit 110 is not blocked, the controller 130 repeatedly controls the internal storage device 120 to store, read, or delete predetermined data in response to the command from the third terminal.

When it is confirmed, according to the result of the determination, that the communication between the third terminal and the second communication unit 110 is blocked, the controller 130 terminates the operation for controlling the internal storage device 120 in response to the command from the third terminal.

According to the router with the storage device and the control method thereof, according to the embodiments, the wired interface unit for wired communication with the external device is provided so that a terminal connected to the router may store predetermined data into the storage device, and read and delete the stored data.

Therefore, terminals may use the router as an external storage device.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A router with a storage device, comprising:
a first communication unit configured to communicate with a first terminal;
a second communication unit configured to perform communication for accessing a network;
an internal storage device capable of storing data; and
a controller configured to link the first and second communication units so that the first terminal accesses the network, and control the internal storage device to store, read, or delete data in response to a command from the first terminal.

2. The router with the storage device according to claim 1, wherein the controller controls the internal storage device to store, read, or delete data in response to a command from a second terminal when the second terminal communicates with the second communication unit through the network.

3. The router with the storage device according to claim 1, wherein the first communication unit performs a Wireless Fidelity (Wi-Fi) communication with the first terminal.

4. The router with the storage device according to claim 1, wherein the second communication unit accesses the network by using one of communication technologies comprising Worldwide Interoperability for Microwave Access (WiMAX), Wireless Broadband Internet (WiBro), High-Speed Uplink Packet Access (HSUPA), and Long Term Evolution (LTE).

5. The router with the storage device according to claim 1, comprising a wired interface unit configured to interface with an external device for data access, wherein the controller controls the internal storage device to store, read, or delete data in response to a command from a third terminal when the external device connected to the wired interface unit is the third terminal.

6. The router with the storage device according to claim 1, comprising:
a wired interface unit configured to interface with an external device for data access;
a key signal input unit configured to generate a key signal according to handling of a user, and output the generated signal to the controller; and
a display unit configured to display an operation of the router according to a command from the controller,
wherein the controller uploads data stored in an external storage device to store the uploaded data into the internal storage device, or backs up data stored in the internal storage device to store the backed-up date into the external storage device in response to the key signal of the key signal input unit when the external device connected to the wired interface unit is the external storage device.

7. The router with the storage device according to claim 1, wherein the internal storage device is a Hard Disk Drive (HDD) or Solid State Disk (SSD).

8. A method for controlling a router with a storage device, the method comprising:
interpreting a command received from a first terminal when the first terminal is connected to and communicates with a first communication unit;
operating a second communication unit for accessing a network, and linking the first and second communication units so that the first terminal accesses the network when the command received from the first terminal is a network access command; and
controlling an internal storage device in response to a data management command from the first terminal when the command received from the first terminal is the data management command.

9. The method according to claim 8, comprising controlling the internal storage device in response to a command from a second terminal when the second terminal is connected to the second communication unit.

10. The method according to claim 8, comprising:
determining a type of an external device when the external device is connected to a wired interface unit; and
selecting data among data stored in an external storage device in response to a key signal received from a key signal input unit, uploading the selected data, and storing the uploaded data into the internal storage device when the external device is determined as the external storage device.

11. The method according to claim 10, comprising selecting data among data stored in the internal storage device according to the key signal received from the key signal input unit, backing up the selected data, and storing the backed-up data into the external storage device.

12. The method according to claim 11, comprising deleting the backed-up data from the internal storage device when the key signal input unit inputs a data deletion command, after the backing up of the data.

13. The method according to claim 10, comprising controlling the internal storage device in response to a command from a third terminal when the external device connected to the wired interface unit is the third terminal.

14. The method according to claim 8, wherein the controlling of the internal storage device comprises storing data into and reading and deleting data from the internal storage device.
